(19) United States
(12) Patent Application Publication
(10) Pub. No.: US 2006/0220350 A1
(43) Pub. Date: Oct. 5, 2006

(54) Bariatric phase chair

(76) Inventors: Rick R. Reef, Delta, OH (US); Eugene W. Ordway, Edgerton, OH (US); Nicholas B. Stanfield, Toledo, OH (US)

Correspondence Address: FRASER MARTIN & MILLER LLC, 28366 KENSINGTON LANE, PERRYSBURG, OH, 43551, US

(21) Appl. No.: 11/389,430

(22) Filed: Mar. 24, 2006

Related U.S. Application Data
(60) Provisional application No. 60/667,317, filed on Mar. 31, 2005.

(51) Int. Cl. A61G 5/00

(52) U.S. Cl. 280/650

(57) ABSTRACT

A bariatric phase chair is disclosed for supporting an obese patient, the chair having a back section, a middle section, and a leg section, wherein the back section and the leg section are pivotable between a raised position and a lowered position for converting the chair to a bed to facilitate examination, emergency care, cardiac care, ambulatory surgery, circulation positioning, orthopedics, physical therapy, diagnostic treatment, recovery, transportation, and the like for the patient.

### CROSS-REFERENCE TO RELATED APPLICATION

This Application claims the benefit of U.S. Provisional Patent Application Ser. No. 60/667,317, filed on Mar. 31, 2005.

### FIELD OF THE INVENTION

The invention relates to a patient management system and more particularly to a bariatric phase chair for supporting an obese patient, the chair having a back section, a middle section, and a leg section, wherein the back section and the leg section are pivotable between a raised position and a lowered position to convert the chair to a bed.

### BACKGROUND OF THE INVENTION

A growing number of people are becoming obese to the point bariatric surgery becomes necessary for the patient to lose weight and avoid a life of obesity. Such surgery involves the sealing off of eighty-five percent (85%) of the patient's stomach. In such procedures, it is necessary to support the patient during the surgical procedure and transport the patient before and after the surgical procedure and during convalescence.

Bariatrics is typically defined as the branch of medicine concerned with the management of obesity and allied diseases. The above-referenced example of bariatric surgery is only one of the examples of an instance where it becomes necessary to support persons of considerable weight. It has been found necessary to deal with persons weighing up to and exceeding one thousand pounds.

Accordingly, it has become necessary to develop beds, stretchers, chairs, and/or tables capable of supporting the weight of obese persons.

It would be desirable to produce a bariatric phase chair which facilitates examination, emergency care, cardiac care, ambulatory surgery, circulation positioning, orthopedics, physical therapy, diagnostic treatment, recovery, transportation, and the like for the patient.

### SUMMARY OF THE INVENTION

Consistent and consonant with the present invention, a bariatric phase chair which facilitates examination, emergency care, cardiac care, ambulatory surgery, circulation positioning, orthopedics, physical therapy, diagnostic treatment, recovery, transportation, and the like for the patient, has surprisingly been discovered.

In one embodiment, the hinge mechanism comprises: a first pin adapted to be connected to a hinging member; a second pin adapted to be connected to the hinging member; a bracket disposed on a stationary member and including an elongate aperture formed therein adapted to slidingly receive the first pin therein; and a slide block adapted to be slidingly received by the stationary member, the slide block including an aperture formed therein adapted to receive the second pin, wherein operation of the hinge mechanism causes a pivotal movement and a linear movement of the hinging member with respect to the stationary member.

In another embodiment, the bariatric phase chair comprises a base; a main frame adapted to be supported by the base; a back section connected to a first end of the main frame and movable between a raised position and lowered position, wherein a raising and lowering of the back section causes a pivotal movement and a linear movement thereof with respect to the main frame; and a leg section pivotally connected to a second end of the main frame.

In another embodiment, the bariatric phase chair comprises a base; a main frame adapted to be supported by the base; a back section pivotally connected to a first end of the main frame and movable between a raised position and lowered position; a leg section having a first end pivotally connected to a second end of the main frame; a foot rest slidingly disposed on a second end of the leg section; and a linkage disposed between the main frame and the leg section, wherein the linkage causes a linear movement of the foot rest with respect to the leg section during a pivoting of the leg section.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a bariatric phase chair according to an embodiment of the invention showing a back section in a raised position and a leg section in a lowered position;

FIG. 2 is a perspective view of the bariatric phase chair illustrated in FIG. 1 showing the back section in a lowered position and the leg section in a raised position;

FIG. 3 is a side elevational view of the bariatric phase chair illustrated in FIGS. 1 and 2;

FIG. 4 is a fragmentary sectional view of a hinge mechanism between the back section and a main frame;

FIG. 5 is a fragmentary exploded rear perspective view of the hinge mechanism illustrated in FIG. 4;

FIG. 6 is a fragmentary elevational view of a hinge mechanism between the leg section and the main frame and showing the leg section in the raised position;

FIG. 7 is a fragmentary elevational view of the hinge mechanism illustrated in FIG. 6 showing the leg section in the lowered position; and

FIG. 8 is a fragmentary perspective view of the hinge mechanism illustrated in FIG. 6 showing the leg section in the raised position.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

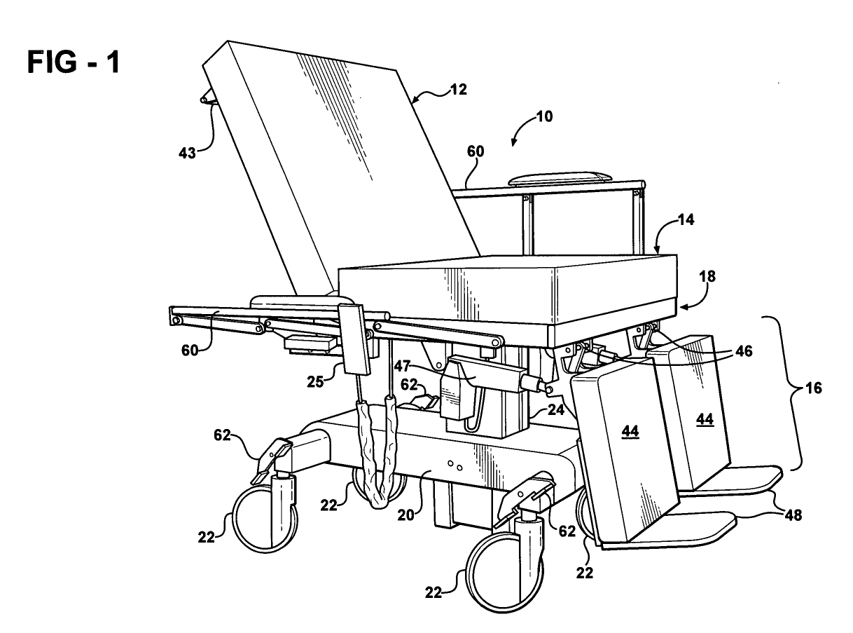

FIGS. 1, 2, and 3 illustrate a bariatric phase chair 10 according to an embodiment of the invention. The bariatric phase chair 10 includes a back section 12, a middle section 14, and a leg section 16, supported by a main frame 18. A base 20 including floor engaging wheels or casters 22 includes an upwardly extending lifting column 24, which supports the main frame 18 thereon. The lifting column 24 can be any conventional type such as manufactured by Linak, for example. A controller 25 in communication with a source of electricity is electrically connected to and controls the lifting column 24. The source of electricity can be a wall outlet or a battery, for example.

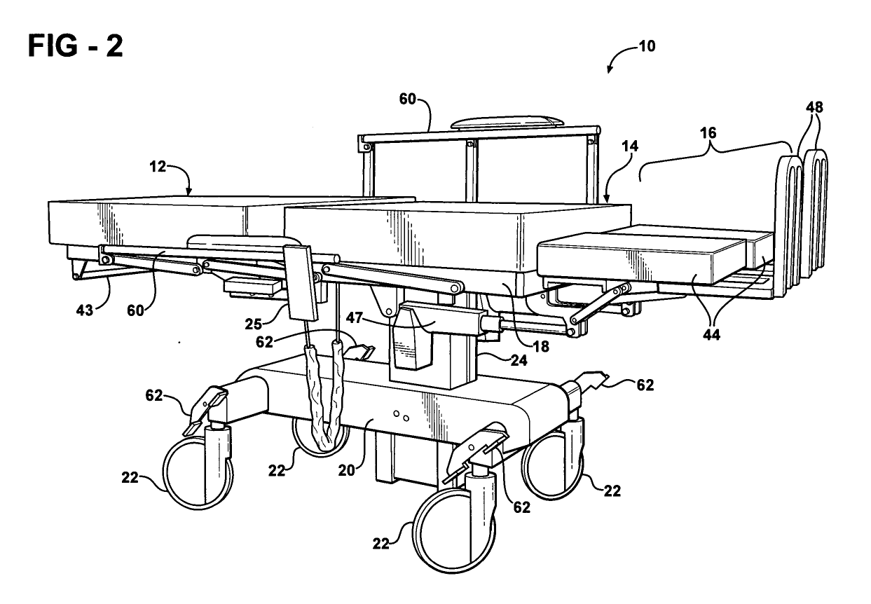

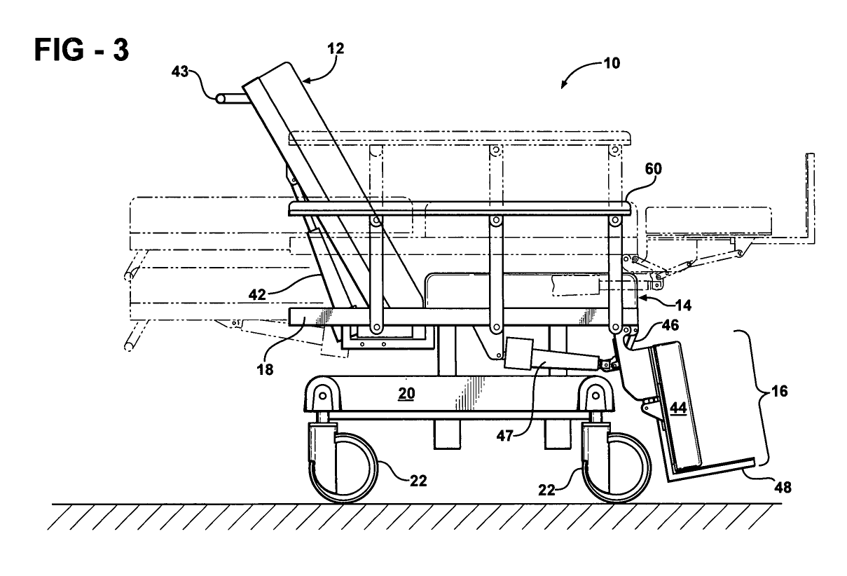

The back section 12 is pivotable between a raised position as illustrated in FIG. 1, and a lowered position illustrated in FIG. 2. The raised position and the lowered position of the back section 12 are also illustrated in FIG. 3.

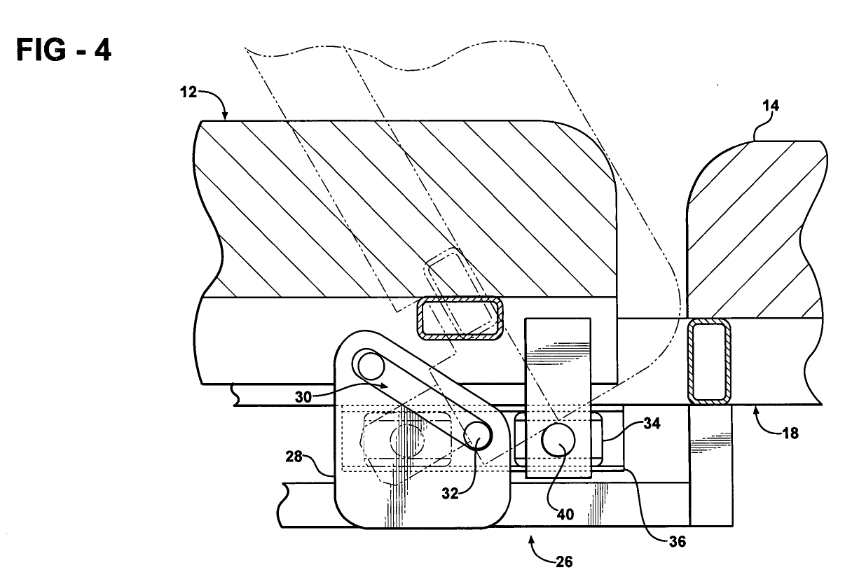

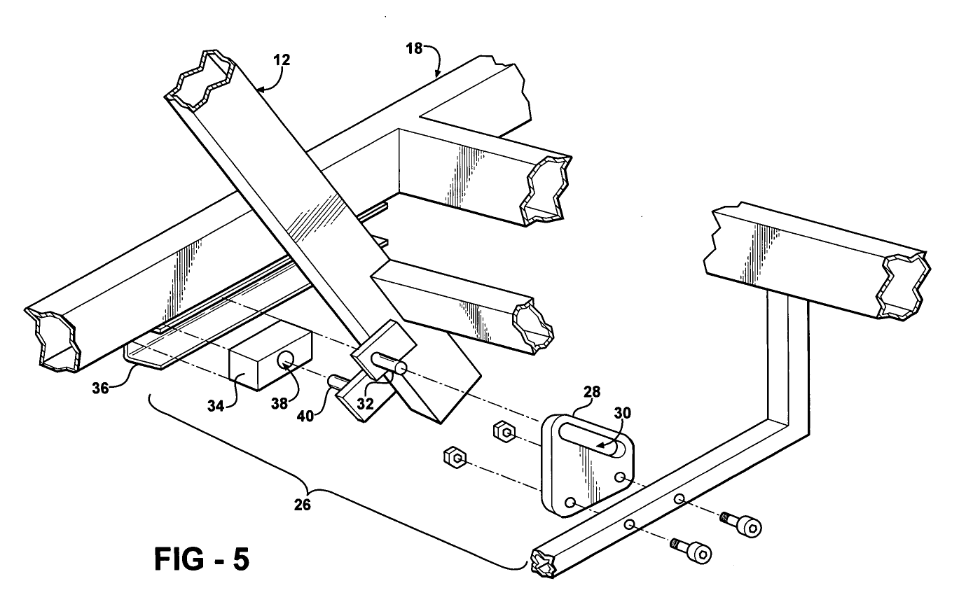

A hinge mechanism 26 pivotally connects the back section 12 and the main frame 18, as is more clearly illustrated in FIGS. 4 and 5. The hinge mechanism 26 includes a bracket 28 connected to the main frame 18. An elongate aperture 30 is formed in the bracket 28 and is adapted to slidingly receive a first pin 32 therein. It is understood that other pin receiving apertures can be formed in the bracket 30 to receive the first pin therein such as a slot or a channel, for example. The first pin 32 is integral with the back section 12. A slide block 34 is slidingly received in a slide channel 36 connected to the main frame 18. An aperture 38 formed in the slide block 34 is adapted to receive a second pin 40 therein. The second pin 40 is integral with the back section 12. An actuator 42 is disposed between the back section 12 and the main frame 18, as clearly shown in FIG. 3. The actuator 42, illustrated in FIG. 3, is activated by the controller 25. The actuator 42 may be an electrically operated linear motor or a pressure fluid operated motor, for example. A push bar 43 is provided on the back section 12 to assist in manual movement of and positioning of the bariatric phase chair 10 by an attendant.

In the embodiment shown, the middle section 14 is supported by the main frame 18 between the back section 12 and the leg section 16 in a substantially horizontal position. Safety rails 60 are provided adjacent both sides of the middle section 14. The safety rails 60 are movable between a raised and lowered position, as illustrated in FIG. 3.

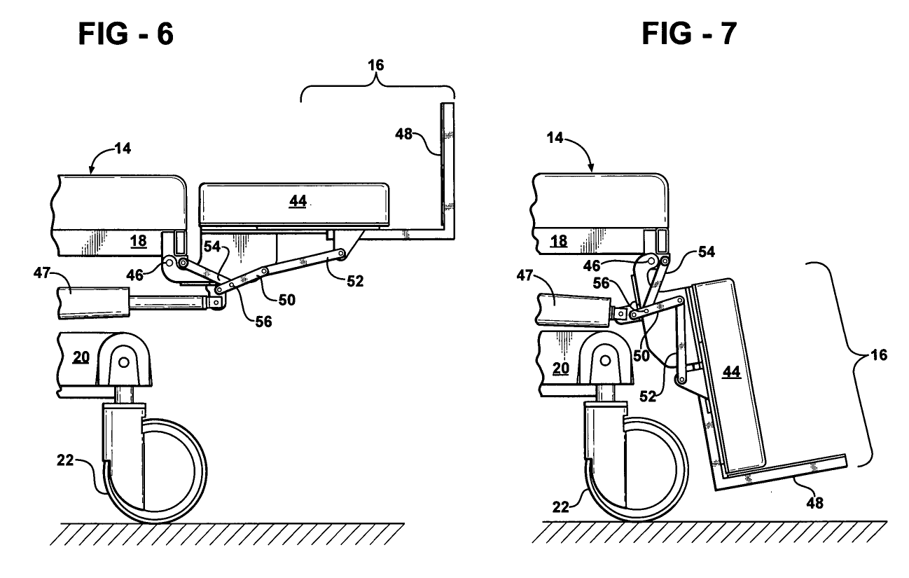

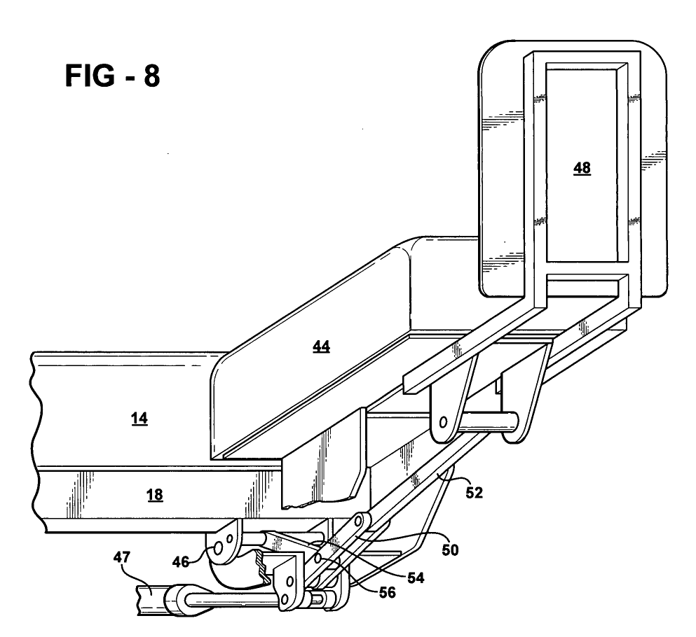

The leg section 16 is pivotable between a raised position as illustrated in FIGS. 2, 6, and 8, and a lowered position as illustrated in FIGS. 1 and 7. The raised position of the leg section 16 is illustrated in FIG. 3 in phantom lines, while the lowered positions in full lines. The leg section 16 includes a pair of leg supporting members 44. Each of the leg supporting members 44 is pivotally connected to the main frame 18 by a hinge 46. An actuator 47, similar to the actuator 42, is disposed between each of the leg supporting members 44 and the main frame 18. The actuator 47 is activated by the controller 25. A foot rest 48 is slidingly disposed at an end of each of the leg supporting members 44. A first linkage 50 is pivotally connected to and extends from the leg supporting member 44 and is hingedly connected to a second linkage member 52. The second linkage member 52 is pivotally connected to the foot rest 48. One end of a linkage arm 54 is hingedly connected to the main frame 18 and the other end of the linkage arm 54 is pivotally connected to the first linkage member 50 at a hinge point 56 intermediate the ends thereof.

In use, the bariatric phase chair 10 can be raised or lowered to a desired height from the floor by activation of the lifting column 24 in an upward or downward manner using the controller 25. The controller 25 also activates the actuators 42, 47 to raise or lower the back section 12 and the leg section 16, as desired. When the back section 12 is in the raised position and the leg section 16 is in the lowered position, a patient is supported in a in a sitting position. The legs of the patient are permitted to extend downwardly from the middle section 14 while being supported by the leg supporting members 44 of the leg section 16. The feet of the patient are supported by the foot rests 48. The back of the patient is supported by the back section 12. When the back section 12 is in the lowered position and the leg section 16 is in the raised position, the patient is supported lying down. The safety rails 60 can be raised and lowered as desired militate against the patient falling from the bariatric phase chair 10 or assist the patient in moving within, exiting, or entering the bariatric phase chair 10.

During raising and lowering of the back section 12, the hinge mechanism 26 causes both a pivoting motion and a linear motion of the back section 12. As the back section 12 is caused to be raised by the actuator 42, the pin 32 and the slide block 34 are caused to respectively slide in the elongate aperture 30 and the slide channel 36 in a direction away from the middle section 14. Therefore, the back section 12 is caused to move away from the middle section 14 while simultaneously pivoting to militate against contact therebetween. As the back section 12 is caused to be lowered, the pin 32 and the slide block 34 are caused to respectively slide in the elongated aperture 30 and the slide channel 36 in a direction towards the middle section 14. The back section 12 is thereby caused to move towards the middle section 14 while simultaneously pivoting to minimize the gap created therebetween. Therefore, pinching of the patient in the gap between the back section 12 and the middle section 14 and other potential injuries are minimized. For clarity, FIG. 4 shows the position in phantom lines of the various elements of the hinge mechanism 26 with the back section 12 in the raised position.

When the leg section 16 is raised and lowered, the foot rests 48 are caused to be moved outwardly and inwardly, respectively. As the leg section 16 is raised, the first end of the linkage arm 54 pivots relative to the main frame 18. The second end of the linkage arm 54 moves the hinge point 56 of the first linkage member 50 through a constant radius. The linkage members 50, 52 cooperate to cause the foot rest 48 to be moved outwardly from the leg supporting member 44. When the leg section 16 is lowered, the linkage members 50, 52 cooperate to cause the foot rest 48 to be moved inwardly towards the leg supporting member 44. Each of the leg supporting members 44 can be raised and lowered independently of the other, as desired.

The bariatric phase chair 10 can be converted from a chair to a bed by lowering the back section 12 and raising the leg section 16. Converting the chair to the bed facilitates examination, emergency care, cardiac care, ambulatory surgery, circulation positioning, orthopedics, physical therapy, diagnostic treatment, recovery, transportation, and the like for the patient.

A safety feature can be added whereby the bariatric phase chair 10 can only be raised and lowered using the lifting column 24 when the back section 12 is in the lowered position and the leg section 16 is in the raised position. Additionally, locking mechanisms 62 located at each wheel 22 operate to lock all of the wheels 22 when activated.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A bariatric phase chair comprising:
a main frame;
a middle section supported by the frame;
a back section;
a first hinge mechanism pivotally interconnecting the back section to the main frame opposed to and slightly spaced from the middle section to permit the back section to selectively pivot from a first position in alignment with the middle section to a second position at an angle with the middle section;
at least one leg and foot rest section; and
a second hinge mechanism pivotally interconnecting the leg and foot rest section to the main frame opposed to and slightly spaced from the middle section to permit the leg and foot rest to selectively pivot from a first position in alignment with the middle section a second position at an angle with the middle section.

2. A bariatric phase chair as defined in claim 1 including an actuator connected between the main frame and the support to effect selective vertical movement of the main frame.

3. A bariatric phase chair as defined in claim 2 including an actuator connected between the main frame and the back section to effect selective pivotal movement of the back section relative to the frame.

4. A bariatric phase chair as defined in claim 2 including an actuator connected between the main frame and the leg and foot rest section to effect selective movement of the leg and foot rest section relative to the frame.

5. A bariatric phase chair as defined in claim 1 wherein the first hinge mechanism comprises a first pin adapted to be connected to the back section;
a bracket connected to the main frame, the bracket including an elongate aperture to slidingly receive the first pin;
a slide block slidingly received by the main frame, the slide block including an aperture; and
second pin connected to the back section wherein operation of the first hinge mechanism causes a pivotal movement and a linear movement of the back section relative to the main frame.

6. A bariatric phase chair as defined in claim 1 wherein the leg and foot rest section includes leg section pivotally connected to the main frame and a foot rest extensible from the leg section.

7. A bariatric phase chair as defined in claim 6 wherein the second hinge mechanism comprises a linkage between the main frame and the leg section whereby the linkage causes a linear movement of the foot rest relative to the leg section during pivotal movement of the leg section.

8. A hinge mechanism comprising:
a first pin adapted to be connected to a hinging member;
a second pin adapted to be connected to the hinging member;
a bracket disposed on a stationary member and including an elongate aperture formed therein adapted to slidingly receive said first pin therein; and
a slide block adapted to be slidingly received by the stationary member, said slide block including an aperture formed therein adapted to receive said second pin, wherein operation of the hinge mechanism causes a pivotal movement and a linear movement of the hinging member with respect to the stationary member.

9. A bariatric phase chair comprising:
a base;
a main frame adapted to be supported by said base;
a back section connected to a first end of said main frame and movable between a raised position and lowered position, wherein a raising and lowering of said back section causes a pivotal movement and a linear movement thereof with respect to said main frame; and
a leg section pivotally connected to a second end of said main frame.

10. A bariatric phase chair comprising:
a base;
a main frame adapted to be supported by the base;
a back section pivotally connected to a first end of the main frame and movable between a raised position and lowered position;
a leg section having a first end pivotally connected to a second end of the main frame;
a foot rest slidingly disposed on a second end of the leg section; and
a linkage disposed between the main frame and the leg section, wherein the linkage causes a linear movement of the foot rest with respect to the leg section during a pivotal movement of a pivoting of the leg section.
